(19) United States
(12) Patent Application Publication
(10) Pub. No.: US 2008/0109324 A1
(43) Pub. Date: May 8, 2008

(54) BUSINESS MODEL FOR INTERNET COMMERCE

(75) Inventors: John Rosmarin, Manchester, ME (US); Michael Stanga, Plano, TX (US); Aaron Smiley, Augusta, ME (US)

Correspondence Address: Ralph A. Dowell of DOWELL & DOWELL P.C., 2111 Eisenhower Ave, Suite 406, Alexandria, VA, 22314, US

(73) Assignee: MFGDirect.com, Manchester, ME (US)

(21) Appl. No.: 11/873,693

(22) Filed: Oct. 17, 2007

Related U.S. Application Data
(60) Provisional application No. 60/857,118, filed on Nov. 7, 2006.

(51) Int. Cl. G06Q 30/00; G06F 17/30; G06F 19/00

(52) U.S. Cl. 705/26; 705/27

(57) ABSTRACT

A method of e-commere which allows a supplier/manufacturer to display and sell its products to customers without requiring the supplier/manufacturer to maintain a website and where the Supplier/Manufacturer sets the selling price and gross margin requirements for products sold on the website. The supplier/manufacturer needs only input product information using a series of simple web forms to upload its product information to the internet via the website, thus making the supplier/manufacturer's products viewable and purchasable by any potential customer who accesses the website. The website is equipped with electronic data interchange (EDI) software to automate the input of information to the website, to automate the fulfillment of orders and to assist with maintaining inventory control.

### CROSS REFERENCE TO RELATED APPLICATION

This application claims the benefit of and is a Non-Provisional U.S. application of Provisional U.S. Application 60/857,118 filed Nov. 7, 2006.

### BACKGROUND

In today's fast paced world, the internet has become one of the primary means of purchasing goods and services of all sizes and descriptions. This change has moved many suppliers' and manufacturers' customer bases from locations, such as department stores and malls, to the customers' own homes. While shopping from home is not new, the nature of this commerce has changed significantly in the past decade. With most of today's homes having ready access to computers, together with the wide availability of the internet, many millions of dollars which were once spent with catalog shopping have now been replaced with billions and billions of dollars that are now spent with internet shopping.

This move from catalog shopping to internet shopping has left many companies scrambling to regain market shares lost in the transition. While the cost of developing and maintaining a website is an expected, as well as accepted, cost of business for giants in manufacturing, such as Sony®, General Electric®, Whirlpool® and other large companies, this cost can be prohibitive for many companies. In addition to the cost of developing a website, suppliers/manufacturers are subjected to the cost of maintaining the website, which involves much time and effort. The website must not only stay current with new advances in technology, but must also provides a fresh updated look. In addition, the website must be maintained to make certain that it correctly displays products and that information about those products is complete and up-to-date, including information about the supplier's/manufacturer's current inventory. To adequately maintain a working website, a supplier/manufacturer typically needs to employ the services of website engineer, either in-house or from outside the company, and costs associated therewith are prohibitive for some companies This has kept many of these companies from developing a web presence and drastically reduced their share of the available market

One avenue that some companies have utilized to sell their goods is through the use of wholesalers, who then sell the goods to large internet commerce companies, such as Amazon.com®, Staples.com®, Walmart.com® and other online shopping malls. One of the major drawbacks to these relationships is that the original supplier/manufacturer is forced to sell its products at prices much less than the ultimate prices paid by consumers thus reducing the margins the company retains and increasing the price that consumers must pay.

### SUMMARY

A website and business method are developed to assist companies in marketing their products to potential customers over the internet, thereby, facilitating communications between suppliers/manufacturers and potential customers. The described invention is a new method of conducting e-commerce. The website involves a simple method of fill-in-the-blank web forms so as to allow potential suppliers or manufacturers to easily input information regarding products they wish to provide online for purchase by potential online customers, without the need of maintaining their own independent website and, thereby, reducing the cost of the internet sales program. In addition to reducing the cost of maintaining a website incurred by the suppliers/manufacturers, the business method of the present invention allows the suppliers/manufacturers to eliminate all of the middlemen that increase the price of products to the their customers. In addition unlike most current system the Supplier/Manufacturer determines the price at which their product will be sold. Allowing the Supplier/Manufacturer to set the price a product is sold for allows the Supplier/Manufacturer to determine the margin of profit they can expect out of the product.

Further, the developed website is enabled with electronic data interchange (EDI) software that allows the developed website to interact with the suppliers'/manufacturers' existing in-house computer systems to assist with business management. Business management includes a wide range of everyday concerns for today's businesses: tracking inventory, maintaining customer account information, tracking shipping information, producing reports, etc. As a result, the system allows both tracking of additions to inventory due to manufacturing and return merchandise authorization(RMA), as well as subtractions due to outgoing orders to customers.

This developed website completely automates the communications between a supplier/manufacturer and an online customer. In addition, the present method reduces most of the interaction required between the supplier/manufacturer and its online customers, without increasing the cost of products for sale. At the same time, the system reduces the amount of expense incurred by the supplier/manufacturer in maintaining its own website.

### DESCRIPTION OF DRAWINGS

FIG. 1 shows a schematic of communications and transactions between a website, suppliers/manufacturers and customers.

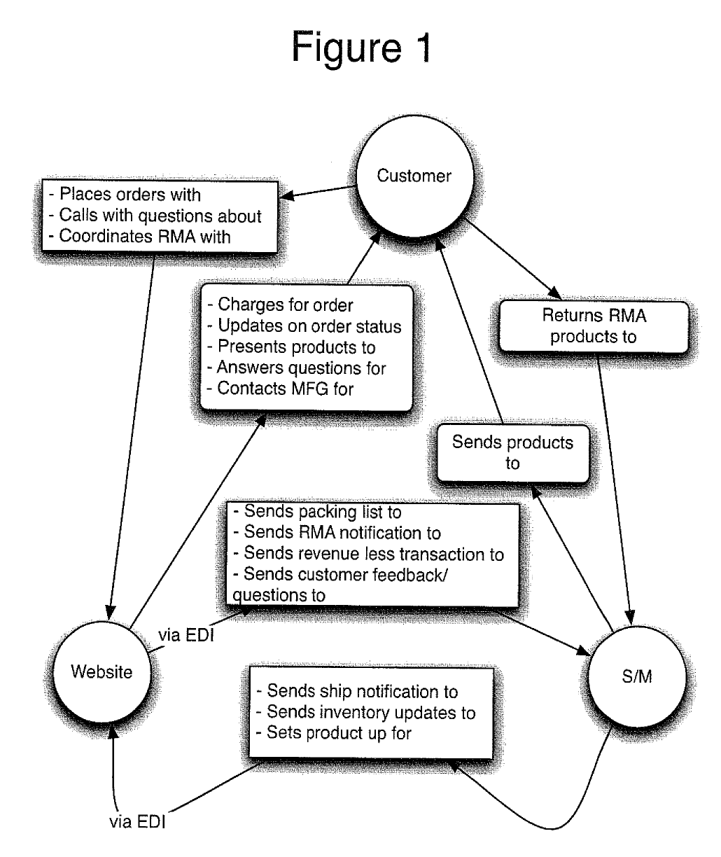

FIG. 2 shows a schematic of a process of inputting product information on the website.

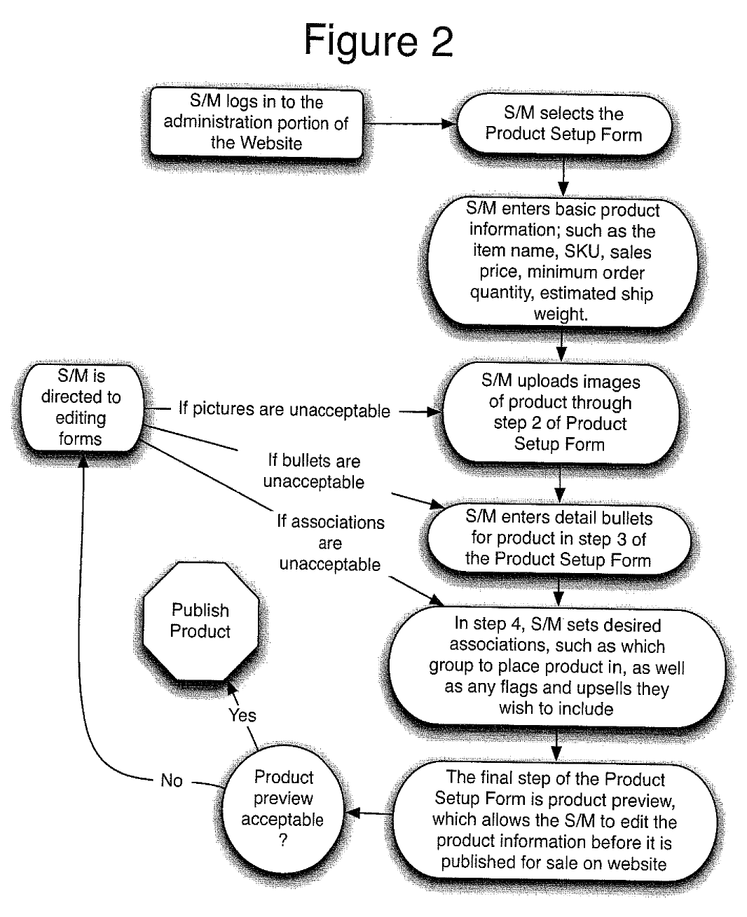

FIG. 3 shows a schematic of a process of fulfilling an order placed by a customer on the website.

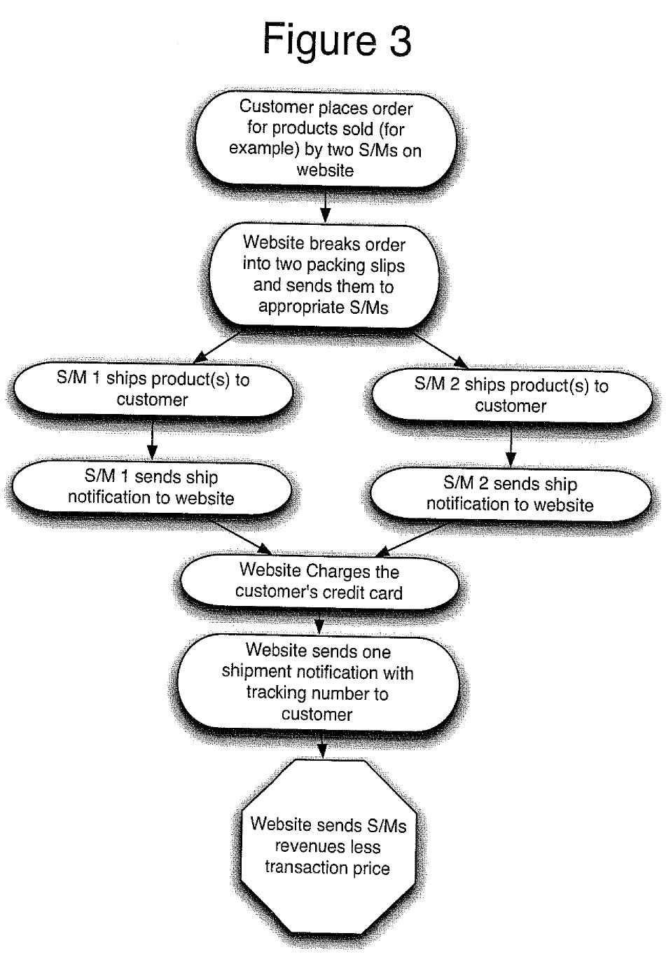

### DETAILED DESCRIPTION OF THE INVENTION

The present website and business method are developed to enable communication between suppliers/manufacturers and potential online customers. The term “customers” is used to name anyone who would access the website to purchase products. One notable definition of a customer accessing the website would be an End User, someone purchasing the product for their own use. To facilitate access for both the suppliers/manufacturers and potential online customers, the present website is overseen by a network of people known collectively as the “website team” or “web group”. The website team's role includes assisting suppliers/manufacturers with preparing protocols and assisting online customers in making their purchases

The Supplier/Manufacturer

In a first step in the method, a potential supplier/manufacturer reviews the terms and conditions for a website set by the website team in order to take advantage of the benefits offered by the website. The terms and conditions can include such items as the cost for preforming such a service, which could include a set percentage of the retail price of the product, guidelines for placing an item on the website, and other terms or conditions dictated by the website team. Once the supplier/manufacturer agrees to the terms and conditions, the supplier/manufacturer may continue with the process of entering product information for publishing on the internet website.

The next step in the process is to set up protocols for communication between the supplier's/manufacturer's computer system and the website computer system to enable inventory controls, monitoring capabilities, and additional reporting means. The website contains commercially available software for electronic data interchange (EDI). This allows the website team to communicate with the potential supplier's/manufacturer's existing in-house computers and thereby automating much of the inventory control associated with e-commerce.

To proceed with the automation of the communications between the supplier's/manufacturer's computers and the website computers, electronic data interchange (EDI) software contained within the website computer is used. The specifications that the supplier's/manufacturer's computers will need to meet in order to facilitate the use of the EDI software are displayed on the website. This allows the supplier/manufacturer to set the necessary protocols for its computer system to communicate and exchange data with the website computer system. These protocols are set out by the website team and provided as “data maps” which describe the format that the files must adhere to in order to be transmitted between the supplier's/manufacturer's computer system and the website computer system. In addition, these “data maps” explain what information the supplier/manufacturer can expect to receive and what information the website team will need in return. The website team can also release information that allows the supplier/manufacturer to provide automated product updates. Once these EDI software specifications are met, the supplier/manufacturer may proceed to the next step.

The third step requires the supplier/manufacturer to fill out web forms to describe the products it wishes to display on the website. The web forms are simple, fill-in-the-blank forms that allow the supplier/manufacturer to input all the necessary information to properly describe the product they wish to display on the internet such as the price for the product. This information may also include a brief description of the product such as dimensions, weight, pricing information, quantity order requirements, SKU (Stock Keeping Unit) number and other descriptive terms. The descriptive terms include group and sub-group placement, flags, or upsells. Examples of group or subgroups placements are “Arts and Crafts”, “Break Room Supplies”, and examples of flags for a black plastic clipboard could include “black” and “plastic”. Further an upsells is an offer for a related product, such as, batteries for a cameras. In addition to descriptive terms, the web forms also provide a means for image uploading. Additional forms are also provided for any additional information the supplier/manufacturer may wish to provide.

Once all information required by the website team and any additional information that the supplier/manufacturer believes is necessary have been inputted onto the forms, the website provides the supplier/manufacturer with an opportunity to preview the product presentation. If the supplier/manufacturer is pleased with the preview, then the item is published for sale. If the supplier/manufacturer is unhappy with the display, then the supplier/manufacturer is given an opportunity to correct any problems. Once all problems are corrected, the supplier/manufacturer is again given an opportunity to preview the information, and then the product display is ready for publishing.

Once a product is added to the website and ready for publishing, an electronic notification is sent to the website team. This electronic notification enables the website team to monitor activity on the website. This electronic notification can be issued at any time, allowing potential suppliers/manufacturers to upload product information at any time, as opposed to only during regular business hours. Electronic notification of product display on the website allows the website team to control what items are placed on the website and published to ensure control of the product content placed on the website.

It is the responsibility of the supplier/manufacturer to maintain their listing, including updates for changes in the product, updating inventory information, and other information required to be updated. To assist with maintaining listed products, the EDI software is utilized. Through the use of the EDI software, a protocol is established to monitor the amount of inventory of a given product based on supply added through manufacturing, deleted by sales, or added back by return to merchandise authorization. Further, it is the responsibility of the supplier/manufacturer to make certain that an accurate representation of the inventory is maintained on the website at all times. Therefore a product listing can be linked to the amount of inventory on hand for a certain product. For example, a “Product X” is listed and linked to inventory controls. When the amount of inventory on hand falls below a prescribed level, “Product X” is removed from the website until inventory levels rise. Once inventory levels rise up to a prescribed level “Product X” will be re-listed on the website.

An additional advantage of the EDI software is allowing the website team to provide reports to the supplier/manufacturer to assist with maintaining an accurate inventory of its products. The EDI software can be used to produce reports on sales of a particular product, the margin of revenue received on a particular product, or other reports the supplier/manufacturer requires. The production of such reports allows the website team to view the reports and provide suggestions based on the movement of products and the margins of certain products to assist in maximizing profit margins and product distribution.

The Customer

A first step involves a potential customer accessing the website. The potential customer can access product information available on the website through a variety of search methods. Some of the methods of searching included on the website are keyword searching, browsing by a selected category, as well as additional conventional searching methods. A customer may also input the Universal Product Code (UPC) number for a particular product and pull the item up directly, rather than searching via the lesser precise name/description search which can return many results. In addition to the described searching methods, a potential customer can utilize a customer assistance system provided on the website. A customer can access the customer assistance system directly on the website or via the

The website team is designated as a source of knowledge for the products placed on the website. This designation allows the website team to provide assistance to the online customer, not only in finding a certain product, but also in giving recommendations for products of interest.

Once a product has been found using any of the above described methods, the customer is then given the opportunity to view product details provided by the supplier. These details can include dimensions, weight of the product, as well as minimum order requirements, images of the product and any other relevant information the supplier/manufacturer inputted. The customer may also be given specific product choices, such as color, size or other specific product features.

Once a specific product has been selected, the customer adds the item to his/her cart through the use of a computer button interface provided on the webpage. The customer inputs a product quantity which meets the supplier's/manufacturer's quantity restrictions. The customer is also given an opportunity to continue shopping or proceed to check-out. Once the customer has finished shopping, the customer is prompted to check-out. During check-out, the customer is asked to input a shipping address where the selected products will be shipped and is given an opportunity to enter an alternative billing address.

Once the address information has been entered, the customer is asked to enter payment information by selecting from a variety of approved payment methods, such as credit cards, electronic computer payment accounts, money order, check or other acceptable payment means. The website captures the selected payment information and reserves the amount on the account the customer has provided. If this reservation fails, then the customer is prompted to provide an alternate payment form and the process is repeated.

Once all information is obtained from the customer, the website team provides the necessary product information to the supplier/manufacturer, including the shipping address information. All of this information is exchanged using the EDI software for exchange between the website computer system and the supplier/manufacturer computer system so that the supplier/manufacturer does not have to manually enter the data.

Once notified that a product has been purchased, the supplier/manufacturer has the obligation to procure a shipping agent for shipment of the product to the customer. In addition to procuring the shipping agent, it is the responsibility of the supplier/manufacturer to pay for the cost of shipping the product to the customer. Once the product has been shipped to the customer, the supplier/manufacturer notifies the website via the EDI software system, that the product has been shipped.

Once the product is received the customer has a set time in which to examine the product to determine if the product is satisfactory. That is, there is a time limit which starts at the onset of delivery of the product in which the product can be returned to the supplier/manufacturer if the product is deemed to be unsatisfactory. Once this set period of time has passed, any problems with the product would fall under the warranty provided for the replacement, repair or refund of the product.

Upon receiving the notice that the product has been shipped, the website completes the process of collecting the required funds from the customer's payment method so that the customer's account will be charged for the item. The website deducts the pre-determined fee from the funds collected and forwards the remaining funds to the supplier/manufacturer.

The above description is summarized as follows: a method of business conducted on a website to assist both suppliers/manufacturers and customers with conducting business over the internet. The website team provides a series of simple web forms that allows the supplier/manufacturer to upload their product to the internet via the website for purchase by customer To streamline this process the website is equipped with EDI software to automate maintaining inventory control. The EDI software is transmitted to the supplier/manufacturer to assist with this automation. This method allows business that would not be able to afford to develop and maintain a website to have a highly automated website for customers to use for purchasing their product.

The foregoing description of the preferred embodiment of the invention has been presented to illustrate the principles of the invention and not to limit the invention to the particular embodiment illustrated. It is intended that the scope of the invention be defined by all of the embodiments encompassed within the following claims and their equivalents.

What is claimed is:

1. A method for selling products directly from a supplier/manufacturer to a customer comprising:
providing a website with a computer system on which products may be displayed for purchase by a consumer;
providing a supplier/manufacturer with online capabilities including:
a) a supplier/manufacturer accessing a website;
b) linking a supplier's/manufacturer's computer system with said website's computer system to assist with business management;
c) inputting product information from the supplier/manufacturer;
d) publishing said product information online so as to be viewable on said website;
providing a customer with online capabilities including:
a) the customer accessing said website;
b) the customer searching said product information published on said website;
c) the customer purchasing said products published on said website and;
whereby, said website automatically updates said supplier's/manufacturer's computer system to notify said supplier/manufacturer to ship said product purchased by said customer directly to said customer, collects payment from said customer once shipment has occurred, and forwards said payment to said supplier/manufacturer.

2. The method of claim 1 further comprising:
providing said supplier/manufacturer with a list of terms and conditions to post product on said website.

3. The method of claim 2, whereby
said terms and conditions must be accepted by said supplier/manufacturer in order to proceed with use of said website.

4. The method of claim 2, whereby
said terms and conditions require said supplier/manufacturer to pay a pre-determined percentage of a retail price of said product listed on said website

5. The method of claim 1 further comprising:
allowing said supplier/manufacturer to determine the price of the product for sale on said website.

6. The method of claim 1, whereby
said business management includes using an electronic data interchange software.

7. The method of claim 6, whereby
said electronic data interchange software is used to assist with said business management including monitoring incoming inventory, monitoring outgoing inventory, and producing reports.

8. The method of claim 6, whereby
said business management includes removing said product from said website if inventory levels drop below a pre-determined quantity.

9. The method of claim 8, whereby
said business management includes re-publishing said product on said website once inventory levels rise above said pre-determined quantity.

10. The method of claim 1, whereby
said inputting of said product information is accomplished by using fill-in-the-blank forms.

11. The method of claim 10, whereby
said product information includes dimensions, weight, descriptive terms, image uploading, SKU number, flags, groups, sub-groups, upsell information and quantity order requirements.

12. The method of claim 1 further comprising:
publishing said product information to include the ability to preview said product information prior to publishing said product information on said website.

13. The method of claim 1 further comprising:
allowing a website team to review said product information prior to said product information being published on said website for quality control.

14. The method of claim 1, whereby
said searching includes methods such as keyword, browsing by category, UPC number, or other standard searching methods.

15. The method of claim 1, whereby
said website assists said customer with selection of said product via telephone or webchats.

16. The method of claim 15, whereby
said website assistance includes details of said products, specials of said products and recommendations of said product available for purchase by said customer on said website.

17. The method of claim 1 further comprising:
providing payment information for purchase of said products by said customer.

18. A method for selling products directly from a supplier/manufacturer to a customer comprising:
providing a managed website with a computer system;
providing a supplier/manufacturer with online capabilities including;
a) accessing the website;
b) linking a supplier's/manufacturer's computer system with the website's computer system to assist with business management;
c) inputting product information;
d) publishing said product information online so as to be viewable on said website;
allowing a customer to access and purchase products from the website;
whereby, said website automatically updates said supplier's/manufacturer's computer to notify said supplier/manufacturer to ship said purchased product directly to said customer, collects a payment once shipment has occurred, and forwards said payment to said supplier/manufacturer.
